(19) United States
(12) Patent Application Publication
(10) Pub. No.: US 2012/0042452 A1
(43) Pub. Date: Feb. 23, 2012

(54) DEW CONDENSATION-PREVENTING MATTRESS AND A METHOD OF MANUFACTURING THEREOF

(75) Inventor: Nobuyuki TAKAOKA, Gamagori-shi (JP)

(73) Assignee: C-ENG CO., LTD., GAMAGORI-SHI (JP)

(21) Appl. No.: 12/860,130

(22) Filed: Aug. 20, 2010

(51) Int. Cl. A47C 27/00; B68G 7/00

(52) U.S. Cl. 5/691; 5/739; 5/423; 29/91.1

(57) ABSTRACT

Dew condensation-preventing mattress is constructed to have a three-dimensional netted structure by extruding a molten material containing at least a thermoplastic resin into filaments, forming an aggregation of multiple filaments looped and randomly entangled with partial thermal adhesion in a plate-like shape, and cooling down to solidify the plate-like aggregation of the multiple filaments. The three-dimensional netted structure has hard side regions of a higher bulk density formed on left and right longitudinal side faces of the three-dimensional netted structure. The dew condensation-preventing mattress of this arrangement has an effect of dew condensation prevention as well as an effect of body pressure dispersion.

### BACKGROUND OF THE INVENTION

1. Field of the Invention

The present invention relates to a dew condensation-preventing mattress and a manufacturing method of the dew condensation-preventing mattress. Specifically, the dew condensation-preventing mattress of the invention is structured to keep the inner humidity and the inner temperature at adequate levels and to be beneficial to the user's health through its disinfection, sterilizing, and environmental effects.

2. Description of the Related Art

Contemporary houses have structures that are air-tight, which can cause dew condensation. Damp bedding may not be easily dried, and the residual moisture often causes dew condensation in bedding and on the floor surface. The dew condensation accelerates the generation of mold, makes the bedding and the house interior smell bad, may damage the bedding and the house interior, and introduces adverse health effects. The humid bedding environment becomes a breeding ground for mites and is especially undesirable for allergy-based diseases, such as atopic dermatitis. It is, thus, of great importance to assure the air permeability of bedding and to prevent the occurrence of dew condensation. The potential for dew condensation is expected to decrease over the following sequence: bedrooms, living rooms, dining rooms, and closets. People generally stay in their bedrooms for long periods of time and suffer from significant adverse health effects due to mold growth that is encouraged by dew condensation. Prevention of dew condensation in bedrooms is, thus, especially important.

An increase in the internal temperature of the bedding by the user's body heat and increases in the internal humidity of the bedding and the humidity of the air between the bedding and the floor surface by the user's night sweats accelerates the occurrence of dew condensation in the bedding and on the floor surface. Air in contact with the floor surface decreases in temperature, thereby lowering the allowable water vapor content limit. With a temperature decrease, the water vapor in excess of the allowable content limit is released from the air to produce water droplets. The presence of water droplets in the bedding and on the floor surface causes dew condensation. The high humidity is associated with a higher amount of water vapor in the air and causes a higher amount of water vapor to be released from the air under temperature decreasing conditions. Adequate control over the temperature, humidity, and the temperature difference is thus a key factor for the effective prevention of dew condensation.

Various measures against potential dew condensation have been proposed for bedding, especially for mattresses. The occurrence of dew condensation in mattresses is a significant problem. Typical measures against potential dew condensation include the use of duckboards placed under the mattress to assure air permeability and the use of a moisture-absorbing pad placed under the mattress to absorb the moisture. The remedies disclosed in the related art that are relevant to this problem include a method for manufacturing a mattress composed of a material with good air permeability, and a sheet with highly hygroscopic particles applied thereon.

Japanese Patent Laid-Open No. 2000-23799 relates to an efficient method of manufacturing a mattress member that is applicable to bedding mattresses and has air permeability and antifungal effects that prevent the generation of mold caused by the presence of moisture. The manufacturing method of this related art involves the continuous extrusion of a heated molten thermoplastic resin downward from multiple downward-facing nozzles set in an extruder into multiple filaments, followed by the hauling-off of the multiple extrusion filaments in an unsolidified state to a lower position at a slower speed than the extrusion speed. The haul-off causes the multiple sticky filaments to adhere to one another at respective contact areas, thereby forming an aggregation of filaments that form a continuous three-dimensional netted body. Before the three-dimensional netted structure solidifies, projection elements arranged at preset intervals are inserted into one single side face of the three-dimensional netted structure to form recesses. The three-dimensional netted structure is then cooled down, allowed to solidify, and is cut into appropriate lengths. The resultant mattress is composed of a material with good air permeability. This art, however, aims to manufacture a mattress that is easily foldable for convenient transport and storage, and the design is not directed toward remedying dew condensation.

The duckboards, the moisture-absorbing pad, and the moisture-preventing mattress conventionally used as measures against potential dew condensation have several practical problems. These moisture-absorbing or moisture-preventing structures are generally made of rather hard materials that are not conducive to comfortable sleep or body pressure dispersion. The moisture-absorbing or moisture-preventing structures composed of soft materials have yielded insufficient dew condensation prevention and cause uneven sinking of some body parts, resulting in discomfort during sleep. None of related art structures promote comfortable sleep, and all require troublesome maintenance procedures.

### SUMMARY OF THE INVENTION

In order to solve at least some of the problems inherent in the related art discussed above, there is a need in the art for providing a dew condensation-preventing mattress that maintains the internal mattress humidity and the internal mattress temperature at adequate levels to provide a comfortable sleep environment, that provides excellent dew condensation prevention, that assures sufficient body pressure dispersion, and that requires only easy maintenance procedures.

The present invention accomplishes at least part of the requirement mentioned above, as well as other relevant requirements, by way of the various aspects and applications discussed below, taking into account the discovery that air circulation inside a mattress is accelerated by the introduction of hard side regions on the side faces of the mattress or by partially controlling the compression hardness of the mattress.

According to a first aspect, the invention is directed in certain embodiments to a dew condensation-preventing mattress constructed to have a three-dimensional netted structure by extruding a material containing at least a molten thermoplastic resin into filaments, forming an aggregated material comprising multiple filaments looped and randomly entangled via thermal adhesion in a plate-like shape, and cooling the aggregated material down to solidify the plate-like aggregation of the multiple filaments. The three-dimensional netted structure has hard side regions of a higher bulk density formed on the left and right longitudinal side faces of the three-dimensional netted structure.

In one preferable application of the dew condensation-preventing mattress according to the first aspect of the invention, each of the hard side regions has a bulk density in the range of 0.050 g/cm³ to 0.300 g/cm³ and a residual region other than the hard side regions has a bulk density in the range of 0.030 g/cm³ to 0.110 g/cm³, and the hard side regions are made to have a higher bulk density than the bulk density of the residual region other than the hard side regions, that is, the center region. The ratio of the bulk density of the hard side regions to the bulk density of the residual region other than the hard side regions, is preferably within a range encompassing the ratio of hard side regions:center region=1.3:1 to 4:1.

In another preferable application of the dew condensation-preventing mattress according to the first aspect of the invention, each of the hard side regions has a bulk density in the range of 0.025 g/cm³ to 0.100 g/cm³, a residual region other than the hard side regions has a bulk density in the range of 0.015 g/cm³ to 0.080 g/cm³, and the hard side regions are made such that they have a higher bulk density than the bulk density of the residual region other than the hard side regions, that is, the center region. The ratio of the bulk density of the hard side regions to the bulk density of the residual region other than the hard side regions, is preferably within a range encompassing the ratio of hard side regions:center region=1.3:1 to 4:1.

In one preferable embodiment of the dew condensation-preventing mattress according to the first aspect of the invention, the three-dimensional netted structure has hard side regions formed by compressing the left and right longitudinal side faces of the three-dimensional netted structure and/or by increasing the quantity of material supplied to the left and right longitudinal side faces.

The quantity of material supplied to the left and right longitudinal side faces of the dew condensation-preventing mattress may be increased, for example, by increasing the number of filaments per unit area of these longitudinal side faces or by increasing the diameter of filaments in these longitudinal side faces.

In another preferable embodiment of the dew condensation-preventing mattress according to the first aspect of the invention, the three-dimensional netted structure further comprises hard surface layers formed by compressing the left and right longitudinal side faces, a planar top face, and a bottom face. The hard surface layers are made to have a higher relative bulk density than the bulk density of the residual region other than the hard side regions and the hard surface layers.

In still another preferable embodiment of the dew condensation-preventing mattress according to the first aspect of the invention, the three-dimensional netted structure has a center section of a different bulk density formed at a site close to the center of the three-dimensional netted structure in a longitudinal direction and corresponding to a user's lower hips. The center section is made to have a relatively higher bulk density than the bulk density of the residual end sections other than the center section.

In one preferable application of the dew condensation-preventing mattress of this embodiment, the center section has a bulk density in the range 0.035 to 0.110 g/cm³ and the residual end sections other than the center section have a bulk density in the range 0.030 to 0.100 g/cm³.

According to a second aspect, the invention is directed to a manufacturing method for a dew condensation-preventing mattress. The manufacturing method melts a material comprising at least a thermoplastic synthetic resin, and extrudes the molten material downward from multiple openings arrayed in a substantially quadrilateral arrangement into filaments. The manufacturing method causes the filaments to free-fall in a vertical direction to a molding chute having a molding inlet in a substantially quadrilateral shape having dimensions smaller than the dimensions of the substantially quadrilateral arrangements of the multiple openings. The manufacturing method subsequently induces the filaments to loop and randomly entangle with partial thermal adhesion to form an aggregation of filaments and simultaneously causes the aggregation of filaments to come into contact with all four faces of the molding chute, thereby compressing the aggregation of filaments. The manufacturing method then hauls off the aggregation of filaments by means of a pair of endless conveyers, which are arranged to face each other and are set to have a slower haul-off speed than the free-fall speed of the filaments, which submerge the hauled-off aggregation of filaments into water for cooling, thereby solidifying the aggregation of filaments into a three-dimensional netted structure that is subsequently cut to yield a three-dimensional netted structure of desired length.

Four surface regions of the three-dimensional netted structure that are in contact with the four faces of the molding chute are made to have a higher bulk density than the bulk density of a residual region other than the four surface regions.

The terminology describing the ‘substantially quadrilateral’ arrangement of the openings and the ‘substantially quadrilateral’ molding inlet of the molding chute does not strictly mean a quadrilateral shape. The shorter sides of the ‘substantially quadrilateral’ shapes define the left and right side faces of the mattress. The shorter sides are not restricted to straight lines but may be curved according to requirements.

In one preferable application of the invention, the method of manufacturing the dew condensation-preventing mattress further supplies a higher quantity of material extruded from the openings located close to the opposed shorter sides of the substantially quadrilateral arrangement of the multiple openings than the quantity of material extruded from the residual openings supplied to form the hard regions of a higher bulk density on the left and right longitudinal faces of the three-dimensional netted structure.

In one preferable application of the manufacturing method of the dew condensation-preventing mattress, the haul-off speed of the endless conveyers is set to a value within the range from 40 to 65 cm/minute, and the supplied quantity of material extruded from the multiple openings to all regions of the 100 cm² area in the substantially quadrilateral molding inlet of the molding chute is set to a value within the range from 0.200 to 0.400 kg/minute.

It is specifically preferred to set the haul-off speed of the endless conveyers within the range 45 to 55 cm/minute, inclusive, and the quantity of supplied material extruded from the multiple openings to all regions of the 100 cm² area in the substantially quadrilateral molding inlet of the molding chute is set to a value in the range from 0.100 to 0.300 kg/minute.

In one preferable embodiment of the invention, the material of the dew condensation-preventing mattress further contains silver ions.

In one preferable application of the invention, the dew condensation-preventing mattress is coated with a sprayed or applied stable chloride complex.

In another preferable application of the invention, the dew condensation-preventing mattress is equipped with one of a plate heater, a sheet heater, and/or a hot air feeder to prevent a decrease in the internal temperature of another mattress, a bed pad, or a floor surface.

In still another preferable application of the invention, the dew condensation-preventing mattress is placed under a bed pad or another mattress, placed above another mattress, or placed between two other mattresses or between a bed pad and another mattress or is used alone to assure good air permeability of the other mattress, of the bed pad, or to the floor surface.

In another preferable embodiment of the invention, the material of the dew condensation-preventing mattress further contains a fire retardant such as a non-decabromo fire retardant.

In still another preferable embodiment of the invention, the dew condensation-preventing mattress is washable to allow mites to be washed away.

In still another preferable embodiment of the invention, the dew condensation-preventing mattress is floatable on top of a liquid such as water.

The dew condensation-preventing mattress according to the first aspect of the invention may be structured to have harder portions of a higher bulk density formed in specified areas or sites. This arrangement effectively adds additional support to a portion of the user's body, for example, the user's lower backside, and prevents the undesirable sinking of a portion of the user's body while assuring good air permeability. The three-dimensional netted structure of the dew condensation-preventing mattress has a variation of the compression hardness to provide health benefits to the mattress user. More specifically, in the dew condensation-preventing mattress according to the first aspect of the invention, the hard side regions formed on the left and right longitudinal side faces prevent the side faces of the mattress from being crushed by the load of the mattress user lying on the mattress and thereby assure good air permeability inside the mattress. The dew condensation-preventing mattress according to the first aspect of the invention may also have hard surface layers or a center section corresponding to user's lower backside having a high bulk density, while having hard side regions. These arrangements further prevent the mattress from being crushed and thereby further prevent the reduction of air circulation inside the mattress and assure good air permeability inside the mattress. The good air permeability inside the mattress prevents an increase in the internal humidity of the mattress and reduces temperature differences between the inside and the outside of the mattress. This arrangement keeps the internal humidity and the internal temperature of the mattress at adequate levels. The dew condensation-preventing mattress of the invention accordingly has antifungal effects and is beneficial to the mattress user's health.

As the dew condensation-preventing mattress of the invention having any of the above structures and arrangements has adequate levels of compression hardness and elasticity, the dew condensation-preventing mattress may be used alone to allow the mattress user to lie directly on the mattress. The dew condensation-preventing mattress may otherwise be placed under another mattress or a bed pad, be placed over another mattress, be placed between two other mattresses, or be placed between a bed pad and another mattress. The good air permeability inside the dew condensation-preventing mattress improves the bedding environment and adequately enhances the air permeability between the dew condensation-preventing mattress and the floor surface and between the dew condensation-preventing mattress and another mattress. The interface between a mattress and a floor surface and the interface between two mattresses are often damp and promote mold growth. The dew condensation-preventing mattress of the invention has desirable antifungal effects.

The dew condensation-preventing mattress of the invention does not have a hygroscopic nature and, accordingly, does not require any special maintenance, for example, airing the mattress to release the moisture, as is required by conventional moisture-absorbing pads used for humidity control. The dew condensation-preventing mattress of the invention is washable and accordingly does not become a collection place for house dust and a breeding ground for mites, bacteria, and mold. The dew condensation-preventing mattress equipped with a heater or a hot air feeder lowers the internal humidity which enhances the antifungal effects of the dew condensation-preventing mattress. The antifungal effects may be enhanced by adding silver ions to the material of the dew condensation-preventing mattress or by spraying or applying a stable chloride complex to the dew condensation-preventing mattress. The reduction of house dust, mites, bacteria, and mold effectively prevent allergy-based diseases, such as atopic dermatitis and asthma, from worsening.

The dew condensation-preventing mattress of the invention is preferable for use on airplanes or ships, especially in military ships, due to its antibacterial, fire-retardant, and floatation properties. It is also preferable for use in medical service settings due to its antibacterial and fire-retardant properties.

The method of manufacturing the dew condensation-preventing mattress according to the second aspect of the invention enables the dew condensation-preventing mattress of the invention to be efficiently manufactured.

### BRIEF DESCRIPTION OF THE DRAWINGS

FIG. 1A shows a diagrammatic perspective-view representation of a dew condensation-preventing mattress 1 in one embodiment according to the invention;

FIG. 1B shows a diagrammatic perspective-view representation of the dew condensation-preventing mattress 1 having different bulk densities in different sites;

FIG. 2A shows a diagrammatic front-view representation of the dew condensation-preventing mattress 1 having different bulk densities in different sites;

FIG. 2B shows a diagrammatic front-view representation of one modified structure of the dew condensation-preventing mattress 1 having different bulk densities in different sites;

FIG. 2C shows a diagrammatic front-view representation of another modified structure of the dew condensation-preventing mattress 1 having different bulk densities in different sites;

FIG. 3 shows a diagrammatic representation of a method of manufacturing the dew condensation-preventing mattress 1 of the embodiment;

FIG. 4A is an explanatory view showing one arrangement of multiple openings in a spinneret used in the manufacturing method to supply a fixed quantity of material;

FIG. 4B is an explanatory view showing another arrangement of the multiple openings in the spinneret used in the manufacturing method to increase the supplied quantity of the material in specific regions close to the short sides of the spinneret;

FIG. 4C is an explanatory view showing still another arrangement of multiple openings in the spinneret used in the manufacturing method to increase the supplied quantity of material in specific regions close to the short sides of the spinneret;

FIG. 5 shows a table showing example settings of the thickness and bulk densities in the dew condensation-preventing mattress 1 of the embodiment;

FIG. 6 shows a graph of the time-dependence of the humidity between a floor surface and a dew condensation-preventing mattress 1 without hard side regions (A) and between a floor surface and a dew condensation-preventing mattress with hard side regions (B);

FIG. 7 shows a diagrammatic perspective-view representation of a dew condensation-preventing mattress 1′ in one modified example of the embodiment;

FIG. 8 shows a diagrammatic perspective-view representation of a dew condensation-preventing mattress 100 in another embodiment according to the invention;

FIG. 9 shows a table showing the results of an antibacterial evaluation test of a dew condensation-preventing mattress modification whereby silver ions are added to the material of the dew condensation-preventing mattress 1 of the embodiment; and

FIG. 10 shows a table showing the results of an antibacterial evaluation test of a dew condensation-preventing mattress modification whereby a stable chloride complex is sprayed onto the dew condensation-preventing mattress 1 of the embodiment.

FIG. 11 shows a table showing the results of an evaluation test of washability.

### DETAILED DESCRIPTION OF THE INVENTION

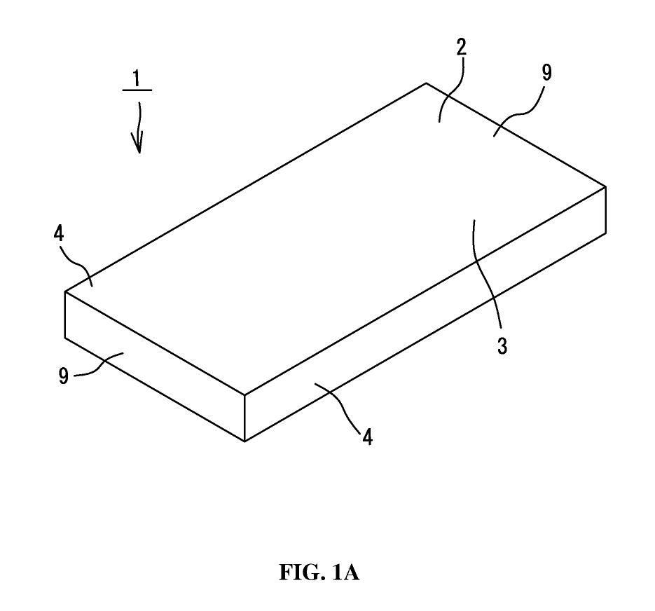

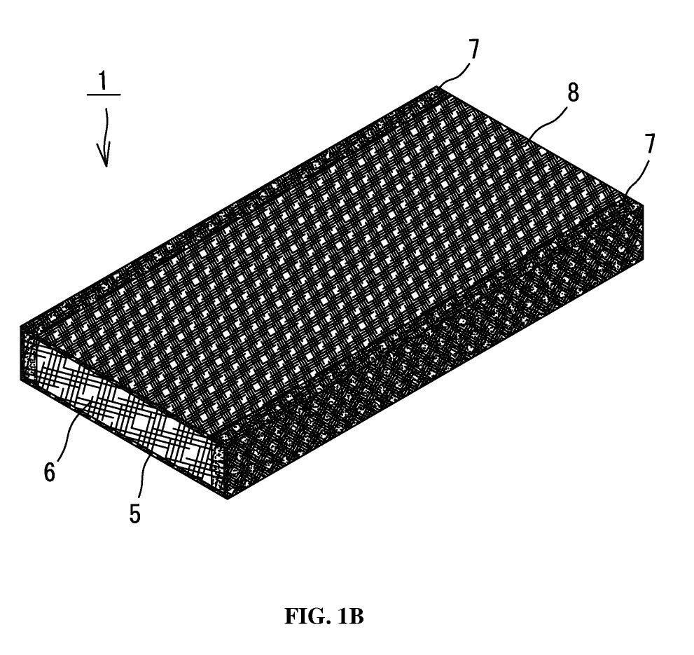

Some modes of carrying out the invention are described below with reference to the accompanied drawings. A dew condensation-preventing mattress 1 in one embodiment according to the invention is described first with reference to FIG. 1. The dew condensation-preventing mattress 1 is provided as a three-dimensional plate-like netted structure that is made of a regenerated thermoplastic resin as a material or a primary material and has material filaments looped and entangled at random held together by partial thermal adhesion. The looped and randomly entangled arrangement of material filaments causes the dew condensation-preventing mattress 1 as a whole to have a spring-like structure and elasticity.

The dew condensation-preventing mattress 1 has four faces, a top planar face 2, a bottom face 3, and left and right side faces 4, formed in a molding step of the three-dimensional netted structure (see FIG. 1A). The front and back end faces 9 are not produced in the molding process but are formed by cutting the three-dimensional netted structure. The molding process compresses the molten material filaments. Each molded face accordingly has a hard surface layer 5 with a relatively high bulk density (see FIG. 1B). The hard surface layers 5 extend from the respective molded faces to preset depths of the interior. The hard surface layers 5 have a relatively higher average bulk density than the average bulk density of the inner layer 6 other than the hard surface layers 5.

The bulk density of the dew condensation-preventing mattress 1 is adjustable by regulating the quantity of material filaments supplied. Increasing the quantity of material filaments supplied to the left and right side faces 4 of the dew condensation-preventing mattress 1 forms hard side regions 7 with a higher bulk density on the respective left and right side faces 4 (see FIG. 1B). In the dew condensation-preventing mattress 1, a center region 8 represents the region other than the hard side regions 7.

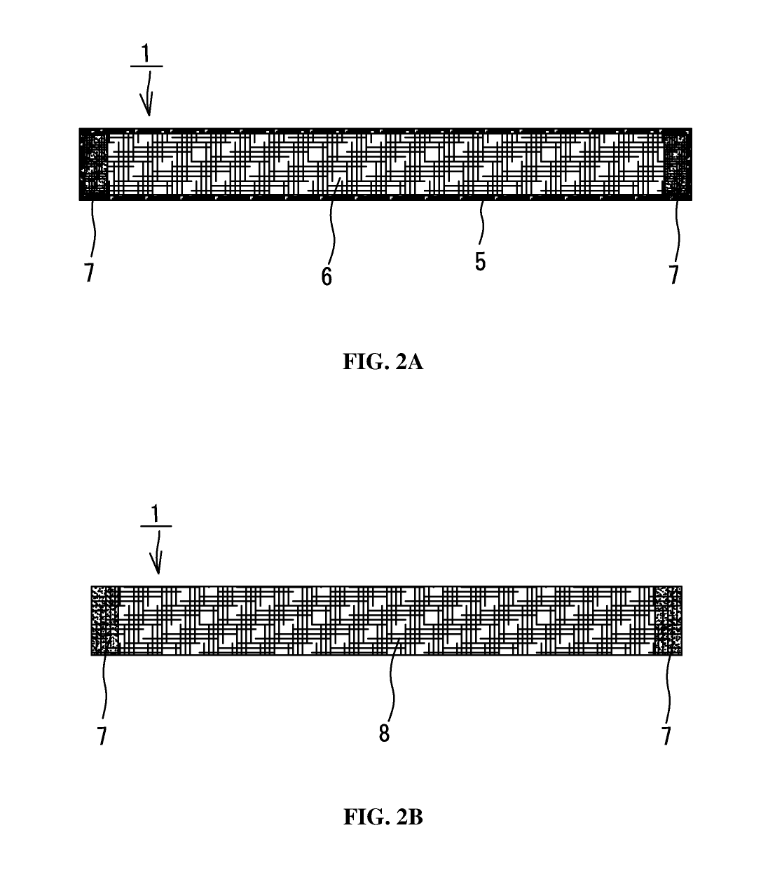

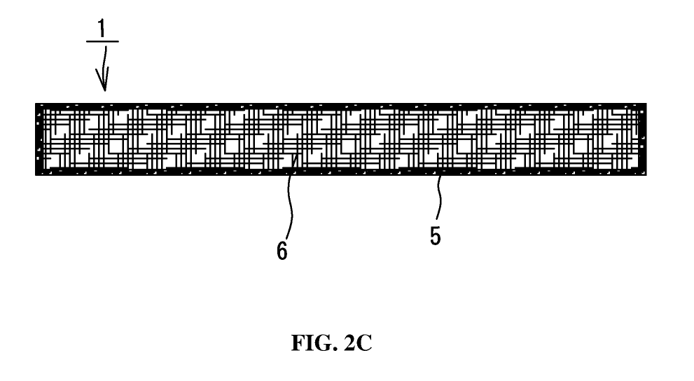

FIG. 2 shows exemplary modified structures of the dew condensation-preventing mattress 1. FIG. 2A shows a diagrammatic front-view representation of the dew condensation-preventing mattress 1 of the embodiment. In one modified structure shown in FIG. 2B, none of the four faces, the top planar face 2, the bottom face 3, or the left and right side faces 4, may be subjected to compression molding, but hard side regions 7 may be formed on the left and right side faces 4 by increasing the supply amount of the material filaments for the left and right side faces 4. In another modified structure shown in FIG. 2C, the four faces, the top planar face 2, the bottom face 3, and the left and right side faces 4, may be subjected to compression molding with a fixed supply amount of the material filaments, and the bulk density of the left and right side faces 4 may be enhanced by increasing the compression rate of the left and right side faces 4.

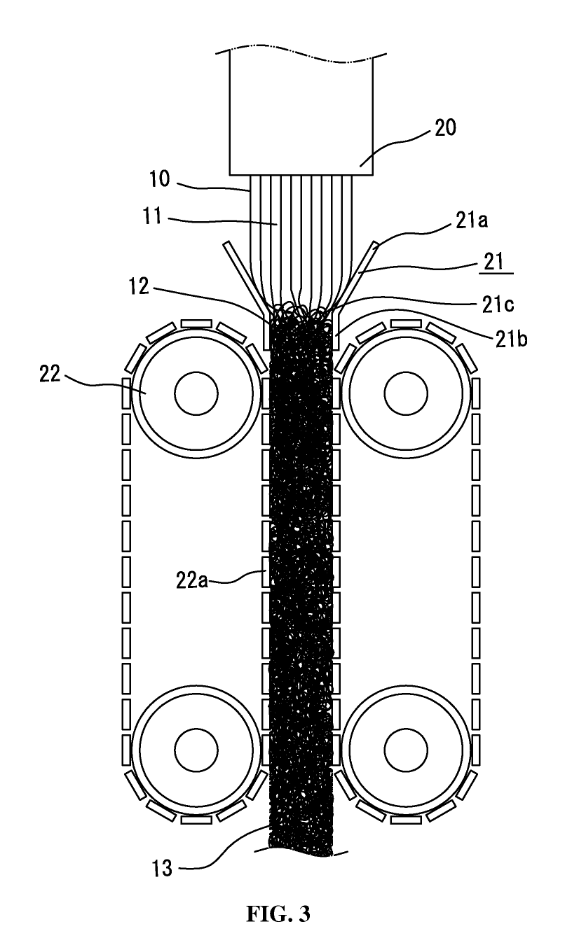

A method of manufacturing the dew condensation-preventing mattress 1 of the embodiment is described below with reference to FIG. 3. In the manufacturing method, steps well known in the art are not specifically described here. For details of such known steps, Japanese Patent No. 4350286 and U.S. Pat. No. 7,625,629 should be referred to.

The manufacturing method first melts a material mixture including a thermoplastic synthetic resin as a primary material and extrudes the molten material mixture through a spinneret 20 into filaments 10. The extruded filaments 10 are made slightly thinner than the bores of the spinneret 20 and free-fall into a molding inlet 21c of a molding chute 21 by gravity.

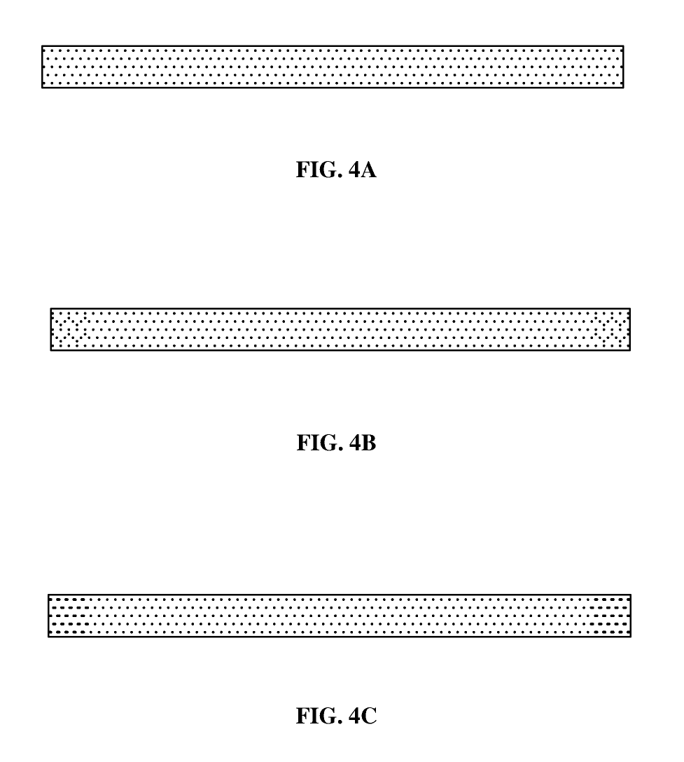

The spinneret 20 has multiple arrays of openings. The filaments 10 extruded from the individual openings of the spinneret 20 form a filament block 11 as a whole. The spinneret 20 with the arrays of openings has a substantially quadrilateral contour, as shown in FIG. 4. The molding inlet 21c is a substantially quadrilateral space having a smaller length and a smaller width than the overall length and the overall width in the arrays of openings on the spinneret 20. The molding chute 21 is a member having four inclined guide plates 21a and four molding plates 21b extending parallel to the downward extrusion direction of the extruded filaments 10. The four inclined guide plates 21a and the four molding plates 21b are arranged in four different directions, and the four molding plates 21b define the molding inlet 21c.

The filament block 11 falling into the molding inlet 21c comes into contact with the guide plates 21a and the molding plates 21b. Such contact disturbs the vertical falling trajectory of the filament block 11 and causes the adjacent filaments 10 to be randomly looped and entangled. Simultaneously, the volume of the filament block 11 is constrained by the guide plates 21a. The four faces of the constrained filament block 11 are then respectively compressed by the four molding plates 21b to form the aggregation 12.

The aggregation 12 is hauled off by a haul-off machine 22. The haul-off machine 22 has a pair of endless conveyers 22a rotating in the same direction as the downward extrusion direction of the filaments 10. The haul-off speed of the haul-off machine 22 is set to a lower speed than the free-fall speed of the filaments 10. Such a setting enables the aggregation 12 to be hauled away without stretching the looped and randomly entangled filaments 10.

In the haul-off machine 22, the pair of endless conveyers 22a are opposed to each other to hold and haul two opposing faces of the aggregation 12. The haul-off machine 22 is equipped with a drive control device (not shown) including a drive motor operated to drive the endless conveyers 22a, a transmission structured to include chains and gears and change the speed of the endless conveyers 22a, a controller, and other instruments.

While maintaining contact with the endless conveyers 22a, the compressed aggregation 12 is submerged in water. The filament block 11 in the molten state is then cooled and solidified to form a three-dimensional netted structure 13. The three-dimensional netted structure 13 is a plate-like structure having a cross section in a specific shape corresponding to the shape of the molding inlet 21c.

The manufacturing method continues this series of operations to produce a continuous body of a three-dimensional netted structure 13 and cuts the continuous three-dimensional netted structure 13 into desired lengths to obtain the dew condensation-preventing mattresses 1. The cutting cross sections each form the front and back end faces 9 of each dew condensation-preventing mattress 1, and the cutting interval specifies a vertical dimension or length of each dew condensation-preventing mattress 1.

The compression rate of the aggregation 12 may be varied by regulating the overall length and the overall width of the arrays of openings formed on the spinneret 20 and the distances between the opposed molding plates 21b. Changing the compression rate controls the bulk density and the thickness of the hard surface layers 5 formed on the three-dimensional netted structure 13. Regulating the dimensions in the arrays of openings formed on the spinneret 20 and the dimensions of the substantially quadrilateral molding inlet 21c to set a higher compression rate in the length direction (in the longitudinal direction) than in the width direction (in the shorter side direction) enhances the bulk density of the side faces of the dew condensation-preventing mattress 1.

Examples of the increased supply of material filaments 10 to form the hard side regions 7 of the dew condensation-preventing mattress 1 are explained with reference to FIG. 4. In a substantially quadrilateral spinneret shown in FIG. 4A, multiple arrays of openings are arranged at fixed intervals to supply a fixed amount of the material filaments. In a substantially quadrilateral spinneret shown in FIG. 4B, both end areas have an increased number of openings to increase the number of extruded filaments 10 and thereby form the hard side regions 7. In a substantially quadrilateral spinneret shown in FIG. 4C, both end areas have slot-shaped openings to thicken the extruded filaments 10 and thereby form the hard side regions 7.

The dew condensation-preventing mattress 1 of the embodiment according to the invention has the properties discussed below. The dew condensation-preventing mattress 1 has adequate compression hardness and elasticity, thus facilitating both comfortable sleep and good dew condensation-preventing effects. The dew condensation-preventing mattress 1 is formed with the three-dimensional netted structure having multiple filaments looped and entangled at random and held together by thermal adhesion. The bulk density is an important index that indicates the properties of the dew condensation-preventing mattress 1. Various thermoplastic resins have specific gravities that are not distinct from that described here. The bulk density of the dew condensation-preventing mattress 1 is thus controllable by the filament diameter, the number of filaments, and the haul-off speed of the filaments.

Typical examples of the thermoplastic resin that may be used as the material for forming the dew condensation-preventing mattress 1 of the embodiment according to the invention include polyolefins such as polyethylene and polypropylene, polyesters such as polyethylene terephthalate, polyamides such as nylon 66, polyvinyl chloride, polystyrene, copolymers of any of these polymers, elastomers, and any mixtures of these polymers. The material may further include an antimicrobial agent. Polyethylene is a specifically preferable material for the dew condensation-preventing mattress 1. The use of polyethylene as the primary material provides enhanced sleep comfort. The bulk density is discussed below for a dew condensation-preventing mattress 1 made of polyethylene as an example. Because polyethylene is a relatively soft material, the dew condensation-preventing mattress 1 made of polyethylene is expected to have a higher bulk density than mattresses made of relatively hard thermoplastic resins.

The diameter φ of the filaments is preferably in a range of 0.2 to 2.0 mm, specifically in a range of 0.3 to 1.5 mm, and more specifically in a range of 0.5 to 0.9 mm. This range is, however, neither essential nor restrictive for producing the hard side regions 7. The filaments may have a greater diameter or may have a greater volume extruded from the slot-shaped openings. The filaments may be solid or hollow.

The technique of the invention is applicable to single-sized mattresses, double-sized mattresses, and any other sized mattresses, for example, mattresses of 600 mm to 2000 mm in width and 1300 mm to 2500 mm in length. In the production process, the dew condensation-preventing mattress is manufactured in an endless shape by the dew condensation-preventing mattress manufacturing method of the invention. Each adequate length of the dew condensation-preventing mattress may thus be rolled. The roll shape is convenient for transportation and distribution.

The dew condensation-preventing mattress 1 has an adequately adjusted thickness, for example, in a range of 15 to 300 mm, specifically in a range of 25 to 150 mm, and more specifically in a range of 30 to 80 mm.

The dew condensation-preventing mattress 1 of the embodiment according to the invention is characterized by different bulk densities in different sites within the mattress. It is preferable that even the low-bulk density site has a bulk density of about 0.020 g/cm³ at a minimum. Bulk densities lower than 0.015 g/cm³ may cause insufficient aggregation of the extruded filaments and damage the functions of the mattress. It is also preferable that a high-bulk density site has a maximum bulk density of about 0.087 g/cm³. Bulk densities higher than 0.087 g/cm³ provide a compression hardness exceeding 19.6 kPa. Such a high compression hardness is unsuitable for mattresses. Compression hardness is explained later. These maximum and minimum values for the bulk density are, however, only given as reference values, and regions of the bulk density of the mattress may partly lie outside of these ranges. A user of the mattress generally does not lie immediately on the hard side regions 7. No significant problems thus arise if the hard side regions 7 have a bulk density exceeding the maximum value.

In the dew condensation-preventing mattress 1 of the embodiment according to the invention, the bulk density of the hard side regions 7 is preferably in a range of 0.050 g/cm³ to 0.300 g/cm³, specifically in a range of 0.070 g/cm³ to 0.250 g/cm³, and more specifically in a range of 0.080 g/cm³ to 0.200 g/cm³.

The bulk density of the center region 8 other than the hard side regions 7 is preferably in a range of 0.030 g/cm³ to 0.110 g/cm³, specifically in a range of 0.040 g/cm³ to 0.095 g/cm³, and more specifically in a range of 0.045 g/cm³ to 0.085 g/cm³.

The ratio of the bulk density of the hard side regions 7 to the bulk density of the center region 8 other than the hard side regions 7 is preferably in a range of hard side regions:center region=1.3:1 to 4:1.

The hard side regions 7 having a higher bulk density and a high rigidity are extended from the end faces to a depth of preferably 40 mm to 90 mm, specifically 50 mm to 80 mm, and more specifically 60 mm to 75 mm.

It is difficult to measure the bulk density of the thin hard surface layers 5. If an average value of the bulk density from the surface to a depth at which there is a distribution of bulk densities that are higher than the bulk density of the inner layer 6 is specified as the bulk density of the hard surface layers 5, the ratio of the bulk density of the hard surface layers 5 to the bulk density of the inner layer 6 is preferably in a range of hard surface layers 5:inner layers=1.5:1 to 6:1.

The average bulk density of the overall dew condensation-preventing mattress 1 is preferably in a range of 0.060 g/cm³ to 0.084 g/cm³, specifically in a range of 0.063 g/cm³ to 0.080 g/cm³, and more specifically in a range of 0.066 g/cm³ to 0.075 g/cm³.

The dew condensation-preventing mattress 1 having the bulk density specified above is preferably obtained by regulating the amount of material supplied per unit time to each 10 cm² area of the molding inlet 21c to between 0.20 and 0.40 kg/minute and by adjusting the haul-off speed of the extruded filaments by the haul-off machine 22 to between 40 and 65 cm/minute.

The compression hardness may be used as an index to indicate the elasticity of the mattress. In the specification herein, ‘compression hardness’ is defined as the pressure per unit area measured when the mattress is compressed in one region to a depth of 10 mm with respect to the original mattress surface position by a load applied to the center of the mattress via a circular disk of 150 mm in diameter. In such a measurement, a generally allowable range of compression hardness for the mattress is about 2.94 to 14.70 kPa. The dew condensation-preventing mattress 1 of the embodiment according to the invention has a compression hardness preferably in a range of 4.90 to 12.74 kPa and specifically in a range of 5.39 to 11.76 kPa.

The compression hardness of the dew condensation-preventing mattress 1 of the embodiment according to the invention should be adjusted taking into account the thickness of the mattress. A greater compression hardness is required for thinner mattresses. A small compression hardness in a thin mattress crushes the three-dimensional netted structure of the filaments and causes part of the load of the mattress user to be directly transmitted to the floor. This significantly worsens the comfort during sleep provided by the mattress and shortens the useful life of the mattress.

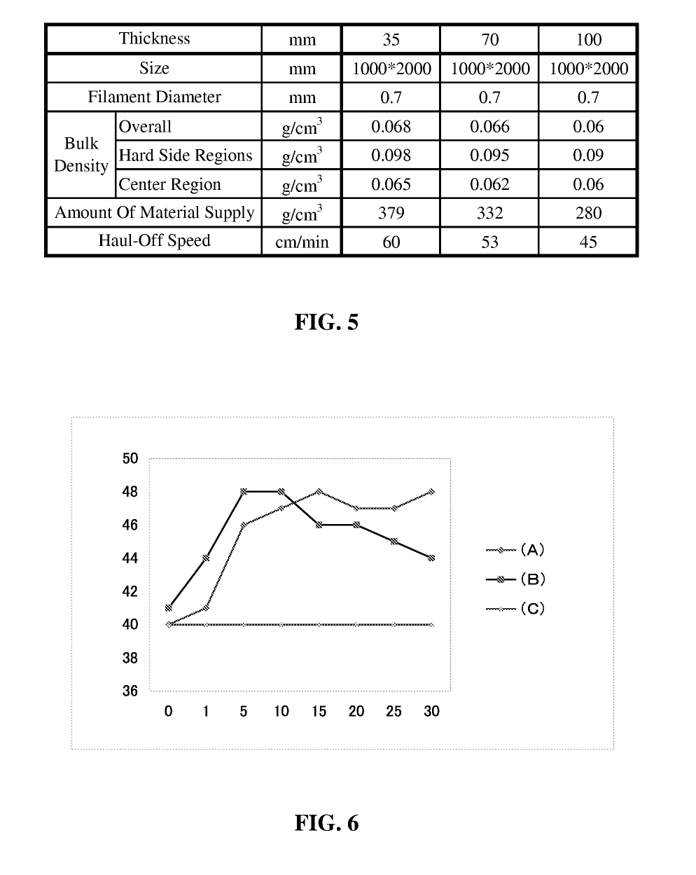

FIG. 5 shows a table of the bulk density of the overall dew condensation-preventing mattress 1, the bulk density of the hard side regions 7, the bulk density of the center region 8, the quantity of material supplied per unit time to each 10 cm² area of the molding inlet 21c, and the haul-off speed measured with respect to the dew condensation-preventing mattresses 1 of various thicknesses, 35 mm, 70 mm, and 100 mm. As discussed previously, each of the dew condensation-preventing mattresses 1 had hard side regions 7 formed by increasing the quantity of material supplied to the left and right side faces 4 and had hard surface layers 5 and an inner layer 6 formed by compressing the top planar face 2, the bottom face 3, and the left and right side faces 4. In this measurement, however, the difference in bulk density between the hard surface layers 5 and the inner layer 6 was not considered. The bulk density of the overall dew condensation-preventing mattress 1, the bulk density of the hard side regions 7, and the bulk density of the center region 8 were determined according to the average bulk densities of the hard surface layers 5 and the inner layer 6. The dew condensation-preventing mattresses 1 had a fixed size of 1000×2000 (mm) and a fixed filament diameter of 0.7 mm φ.

Examples (1), (3), and (5) of the dew condensation-preventing mattress 1 according to the invention and mattresses of comparative examples (2) and (4) were evaluated experimentally. The ideal bedding conditions are a temperature of 33° C.±1° C. and a humidity of 50%±5% (RH). The influence of the thickness of the mattress and the influence of the presence or absence of the hard side regions on the dew condensation prevention were measured experimentally. The dew condensation-preventing effect was evaluated according to whether dew condensation occurred between the floor surface and the mattress in use after the elapse of a predetermined period of time. The mattresses of the comparative examples (2) and (4) had three-dimensional netted structures similar to those of the dew condensation-preventing mattress 1 but without hard side regions 7.

The experimental results indicated: the dew condensation-preventing effect was not observed for the mattress (1) having a thickness of 20 mm, a bulk density of the center region 8 of 0.071 g/cm³, and a bulk density of the hard side regions 7 of 0.082 g/cm³; the dew condensation-preventing effect was not observed for the mattress (2) having a thickness of 35 mm, an overall bulk density of 0.067 g/cm³, and no hard side regions 7; the dew condensation-preventing effect was observed for the mattress (3) having a thickness of 35 mm, a bulk density of the center region 8 of 0.067 g/cm³, and a bulk density of the hard side regions 7 of 0.079 g/cm³; the dew condensation-preventing effect was observed for the mattress (4) having a thickness of 50 mm, an overall bulk density of 0.059 g/cm³, and no hard side regions 7; and the dew condensation-preventing effect was observed for the mattress (5) having a thickness of 50 mm, a bulk density of the center region 8 of 0.059 g/cm³, and a bulk density of the hard side regions 7 of 0.074 g/cm³.

A comparison between the mattress (1) and the mattress (3) shows that a mattress of small thickness does not display the dew condensation-preventing effect. A comparison between the mattress (1) and the mattress (5) shows that the mattress of sufficiently large thickness displays the dew condensation-preventing effect. A comparison between the mattress (2) and the mattress (3) shows that the presence of the hard side regions is effective for dew condensation prevention.

FIG. 6 shows a graph showing the time-dependent humidity between the mattress in use and the floor surface: a plot (A) showing the time-dependent humidity for a mattress without hard side regions and a plot (B) showing the time-dependent humidity for a mattress with hard side regions. The graph of FIG. 6 shows the time elapsed (minutes) as the abscissa and the humidity (%) as the ordinate. A plot (C) shows the time-dependence of the indoor humidity. As clearly understood from the graph of FIG. 6, the humidity plot (B) for the mattress with hard side regions approached the indoor humidity plot (C) over time.

The dew condensation-preventing mattress 1 of the embodiment according to the invention has the following effects. The presence of the hard side regions 7 formed on the dew condensation-preventing mattress 1 gives adequate compression hardness or hardness. This structure effectively prevents the left and right side faces 4 of the dew condensation-preventing mattress 1 from being crushed and unnecessarily deformed by the load of the mattress user lying on the dew condensation-preventing mattress 1, thus assuring sufficient air permeability through the left and right faces 4. As the load applied on the mattress is varied significantly, for example, by the mattress user changing position by turning over, the air within the mattress is moved as by a pumping action. The air permeabilities of the left and right faces 4 allow for large air circulation within the mattress and assure a better pumping effect.

The presence of the hard surface layers 5, especially the hard surface layer 5 formed on the top planar face 2, in the dew condensation-preventing mattress 1 contributes significantly to the pumping effect. The adequate elasticity of the top planar face 2 of the mattress enables the load of the mattress user to be efficiently diffused throughout the overall mattress. The good air permeability of the mattress desirably prevents an increase in the internal humidity of the mattress and reduces the temperature difference between the inside and the outside of the mattress. Keeping the humidity and the temperature within the mattress at adequate levels desirably protects the mattress from mold and is beneficial for the health of the mattress user.

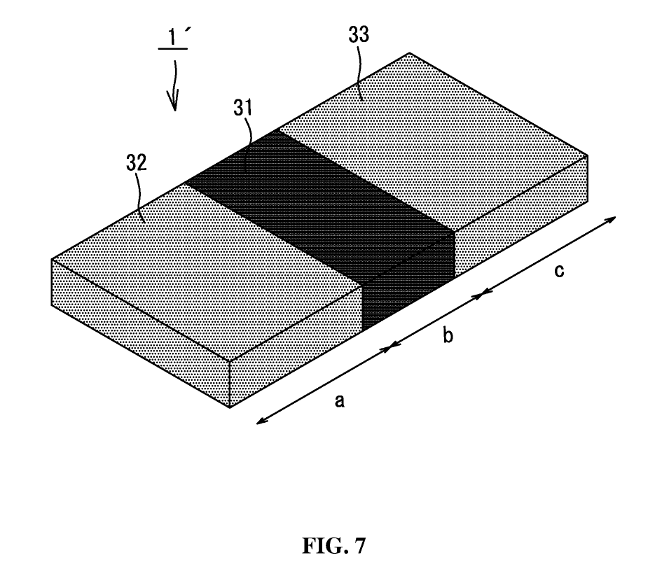

A dew condensation-preventing mattress 1′ of one modified example according to the invention is described below with reference to FIG. 7. The dew condensation-preventing mattress 1′ of the modified example has hard side regions and hard surface layers similar to those of the dew condensation-preventing mattress 1 of the embodiment, which are, however, omitted from the illustration of FIG. 7 for clarity. The dew condensation-preventing mattress 1′ has a center section 31 corresponding to the user's lower backside and end sections 32 and 33. The center section 31 has a bulk density of 0.035 to 0.110 g/cm³, and the end sections 32 and 33 have a bulk density of 0.030 to 0.100 g/cm³.

A manufacturing method of the dew condensation-preventing mattress 1′ of the modified example is described briefly. Changing the haul-off speed at arbitrary intervals varies the bulk density along the direction of the length of the mattress. The speed at which the filaments are hauled-off is inversely proportional to the bulk density. The bulk density decreases with increasing haul-off speed and increases decreasing haul-off speed. The bulk density is proportional to the compression hardness of the mattress. Namely, the compression hardness decreases with increasing haul-off speed and increases with decreasing haul-off speed.

Based on these relations, modulating the haul-off speed varies the compression hardness and produces a dew condensation-preventing mattress 1′ having successive changes in hardness. The dew condensation-preventing mattress 1′ is continuously and integrally formed by increasing the haul-off speed for the sections requiring a small compression hardness and decreasing the haul-off speed for the sections requiring a large compression hardness.

For example, the dew condensation-preventing mattress 1′ shown in FIG. 7 may have a thickness of 100 mm, a width of 950 mm, and a length of 1950 mm. The length ‘a’ of the end section 32, the length ‘b’ of the center section 31, and the length ‘c’ of the end section 33 may be specified by the relation a:b:c=1:1:1. This is, however, not essential or restrictive, and the lengths ‘a’, ‘b’, and ‘c’ may be determined by taking into account various factors.

In the dew condensation-preventing mattress 1′ of the modified example, the center section 31 corresponding to the user's lower backside has a higher bulk density and, thereby, enhanced compression hardness. This structure of the dew condensation-preventing mattress 1′ sufficiently supports the load concentration of the user's lower backside and effectively prevents a potential decrease in the air permeability due to compression of the dew condensation-preventing mattress F.

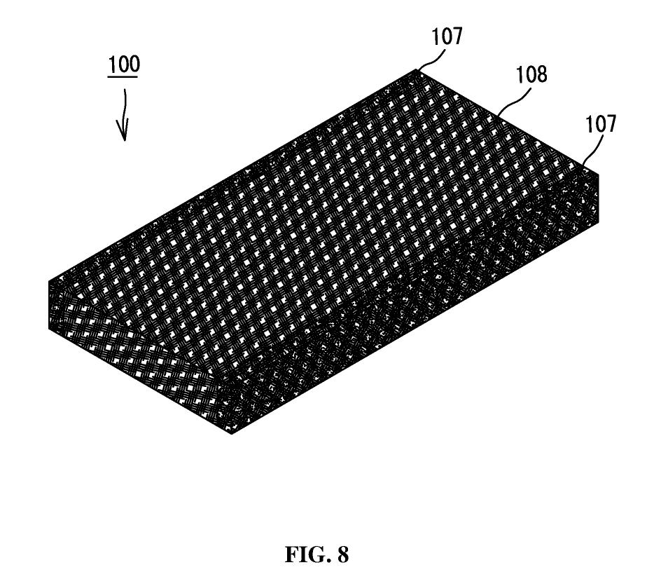

A dew condensation-preventing mattress 100 of another embodiment according to the invention is described below with reference to FIG. 8. The dew condensation-preventing mattress 100 has a center region 108 and hard side regions 107, as in the dew condensation-preventing mattress 1 described above. The dew condensation-preventing mattress 100 may additionally have hard surface layers, although this structure is not specifically described here. The dew condensation-preventing mattress 1 of the above embodiment is structured to give adequate compression hardness and elasticity, thereby attaining both sleep comfort and dew condensation prevention. On the other hand, the dew condensation-preventing mattress 100 of this embodiment is made of a relatively hard thermoplastic resin as a material or primary material so that it has a relatively low bulk density. This structure reduces the total weight of the mattress while assuring sufficient dew condensation-preventing effects. The relatively hard thermoplastic resins are generally inexpensive and often recyclable. The use of such material leads to cost reductions and promotes environmental protection.

Polypropylene and polyethylene terephthalate are typical examples of materials available for use in the dew condensation-preventing mattress 100. When polyethylene terephthalate is used as the primary material, addition of an elastomer is desirable for sufficient adhesion and aggregation of filaments.

In the dew condensation-preventing mattress 100 of this embodiment, the bulk density of the hard side regions 107 is preferably in the range of 0.025 to 0.100 g/cm³, specifically in the range of 0.030 to 0.090 g/cm³, and more specifically in the range of 0.040 to 0.060 g/cm³. The bulk density of the center region 108 is preferably in the range of 0.015 to 0.080 g/cm³, specifically in the range of 0.020 to 0.070 g/cm³, and more specifically in the range of 0.030 to 0.050 g/cm³.

The dew condensation-preventing mattress 1 of one embodiment, the dew condensation-preventing mattress 1′ of its modified example, and the dew condensation-preventing mattress 100 of another embodiment may have a diversity of modifications and applications with various effects, as discussed below. One preferable application of the invention is the addition of silver ions to the material of the dew condensation-preventing mattress, because the silver ions decrease the growth and proliferation of molds, bacteria, and viruses for long periods of time. The dew condensation-preventing mattress made with silver ion-containing materials is expected to have semi-permanent antifungal, antivirus, and antibacterial effects. The addition of silver ions is expected to provide a synergistic effect between antifungal properties and dew condensation prevention.

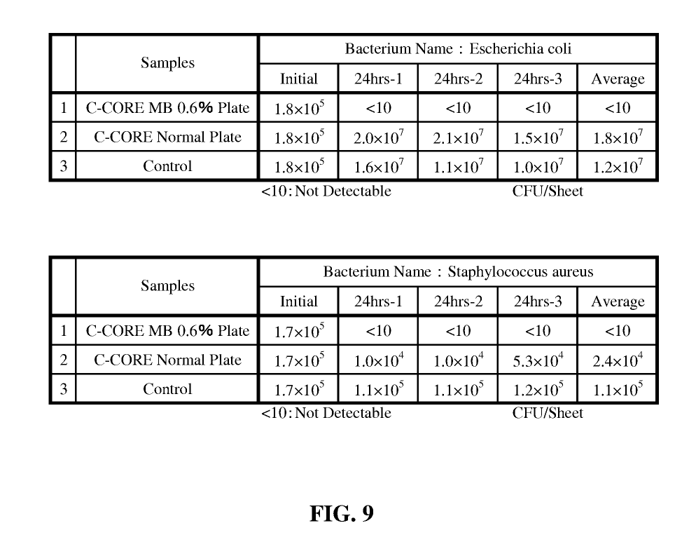

FIG. 9 shows a table of the results of an evaluation test of the silver ion antibacterial properties. The antibacterial properties of the silver ions were evaluated by measuring the bactericidal activity of the silver ions against Escherichia coli (E. coli) and Staphylococcus aureus. Sample 1 comprised a test piece of a mattress of the invention made from a material containing silver ions. Sample 2 comprised a test piece of a mattress of the invention made from a material without silver ions. Sample 3 provided a control sample. Samples 1 and 2 had dimensions 100 mm×100 mm×80 mm, had a bulk density of 0.057 g/cm³, and were composed of polyethylene. The antibacterial property evaluation test was performed according to the guidelines presented in JIS Z 2801. The test procedure delivered a bacterium solution prepared by introducing a 1/500 standard bouillon dropwise onto the surface of each test piece, covering the surface with a film, and maintaining the film-covered test piece at 35° C. The viable bacteria count in the bacterium solution on each test piece was measured over time. The results of the evaluation test demonstrated the antibacterial effects of the silver ions added to the material of the dew condensation-preventing mattress of the invention.

In another preferable application of the invention, a sterilizing agent containing a stable chloride complex is sprayed or applied onto the dew condensation-preventing mattress. The stable chloride complex is known to have excellent antifungal and antibacterial effects. The stable chloride complex is generally not expected to retain antifungal and antibacterial effects for a long period of time, in contrast with the persistence of the silver ion effects, but has the advantage of easy application by a simple spraying procedure. To keep the mattress hygienic, the mattress user would routinely spray the sterilizing agent containing the stable chloride complex onto the mattress.

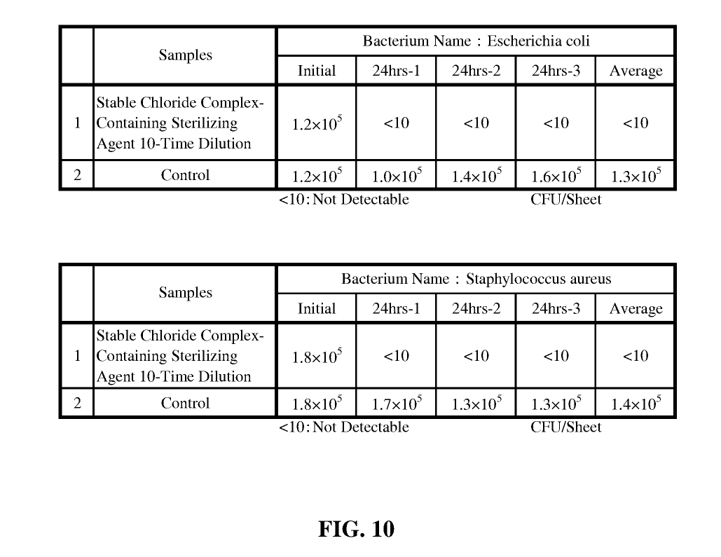

FIG. 10 shows a table showing the results of a test evaluating the antibacterial effects of the stable chloride complex. The antibacterial effects of the stable chloride complex were evaluated as the bactericidal activities of the stable chloride complex against Escherichia coli (E. coli) and Staphylococcus aureus. A sample solution was prepared by diluting a sterilizing agent containing the stable chloride complex to 125 ppm with sterile purified water. The test procedure involved inoculation of 0.1 mL of a 10⁷ bacterium solution into 10 mL of the sample solution, followed by incubation of the inoculated sample solution at 25° C. The viable bacteria count of the inoculated sample solution was measured over time. A control sample comprised 10 mL of sterile purified water inoculated with 0.1 mL of the 10⁷ bacterium solution. The viable bacteria count in the control sample was also measured over time. The results of the evaluation test demonstrated that the extremely effective antibacterial effects against E. coli and Staphylococcus aureus persisted for at least three days. Routine spraying of the sterilizing agent containing the stable chloride complex onto the mattress of the invention at regular intervals thus assures sufficient antibacterial and antifungal effects.

In addition to the excellent antifungal effects by dew condensation prevention, the dew condensation-preventing mattress of the invention is washable. This washable structure is advantageous for removal of the house dust and is effective, in combination with the antifungal and antibacterial effects, for minimizing allergy-based diseases, such as atopic dermatitis.

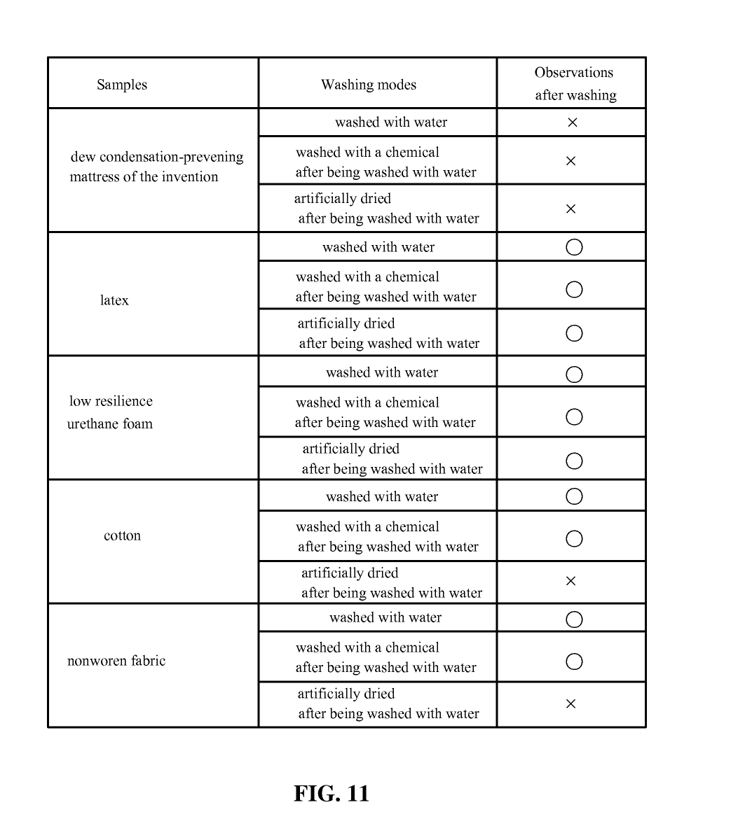

FIG. 11 shows a table showing the results of a washability evaluation test. Washability was evaluated on samples of mattresses made from five different materials, namely, the dew condensation-preventing mattress of the present invention, a latex mattress, a low resilience urethane foam mattress, a cotton mattress, and a nonwoven fabric mattress. First, the incubation medium and house dust mites were dispersed onto each sample. Each sample was observed for three weeks in an incubator maintained at 25° C. House dust mites were observed to be active and alive for three weeks in all samples. This observation confirmed that there is no correlation between the antibacterial effects of a mattress and anti-mite effects. This is because mites are not bacteria, they are minute animals and thus are not affected by the antibacterial properties of cotton, nonwoven fabric, or latex. After confirming the support of a mite population, each sample was washed in three modes. In the first mode, samples were washed by showering with water for 60 seconds. In the second mode, samples were washed with a chemical designed to act against house dust after being showered with water. In the third mode, samples were artificially dried after being showered with water for 60 seconds.

“X” in the table of FIG. 11 indicates that no mites were found in the sample. “O” indicates that mites were found in the sample. As shown in FIG. 11, mites were found in all mattresses except for the dew condensation-preventing mattress of the invention. It was thus demonstrated that house dust mites are completely removed from the dew condensation-preventing mattress of the invention by water washing for about 60 seconds, whereas house dust mites are not completely removed from other mattresses by water washing for about 60 seconds. A void ratio of more than 90% in the dew condensation-preventing mattress of the invention contributes to this high washability. The dew condensation-preventing mattress of the invention can thus be washed easily and completely even at home.

In still another preferable application of the invention, the dew condensation-preventing mattress may be equipped with a sheet or plate heater or with a hot air feeder. Preventing a decrease in internal temperature of the mattress during use prevents a decrease in the temperature of the water vapor, which causes dew condensation, thereby enhancing the dew condensation-preventing effects of the mattress. The material of the dew condensation-preventing mattress according to the invention is not heat-resistant. The sheet or plate heater should accordingly be placed under the mattress such that a heat source is not in direct contact with the mattress. The hot air feeder is also preferably used to prevent a decrease in internal temperature of the mattress while improving the air permeability of the dew condensation-preventing mattress.

The user may directly lie on the dew condensation-preventing mattress of the invention covered with a bed linen. The user may alternatively lie on another mattress or a bed pad placed on the dew condensation-preventing mattress of the invention. The former application assures the dew condensation-preventing effects of the dew condensation-preventing mattress. The former application is especially preferable for the dew condensation-preventing mattress 1′ of the modified example. In the latter application, the user is allowed to lie on the user's desired mattress or bed pad while reaping the benefits of the dew condensation-preventing effect of the dew condensation-preventing mattress. The latter application is similar to conventional mattress applications but has the significantly improved effect of dew condensation prevention. The latter application reduces the frequency with which the mattress is required to be aired and thereby relieves the user's maintenance burden when using the dew condensation-preventing mattress while keeping adequate elasticity to assure comfortable sleep. The dew condensation-preventing mattress of the invention is generally used alone or placed under another mattress or a bed pad. In some other applications, the dew condensation-preventing mattress may be placed above another mattress or may be placed between two other mattresses or between a bed pad and another mattress. Such applications still assure the good air permeability of the dew condensation-preventing mattress and thereby retain the dew condensation-preventing effects.

In another preferable embodiment, a fire retardant, such as a non-decabromo fire retardant, is added to the material of the dew condensation-preventing mattress of the invention.

The dew condensation-preventing mattress of the invention is floatable because the thermoplastic resins have a lower specific gravity than that of water.

The embodiment discussed above should, in all aspects, be considered illustrative and not restrictive. Modifications, changes, and alterations of the design may be introduced without departing from the scope or spirit of the main characteristics of the present invention. All such modifications and changes that fall within the meaning and scope of equivalency of the claims are to be embraced within their scope.

The invention claimed is:

1. A dew condensation-preventing mattress constructed to have a three-dimensional netted structure by extruding a material comprising a molten thermoplastic resin into filaments, forming an aggregation of multiple filaments looped and randomly entangled with thermal adhesion in a plate-like shape, and cooling down to solidify the plate-like aggregation of the multiple filaments, the three-dimensional netted structure having hard side regions of a higher bulk density formed on left and right longitudinal side faces of the three-dimensional netted structure.

2. The mattress of claim 1, wherein each of the hard side regions has a bulk density in a range of between 0.050 g/cm³ and 0.300 g/cm³ and a residual region other than the hard side regions has a bulk density in a range of between 0.030 g/cm³ and 0.110 g/cm³, and the hard side regions are made to have a higher bulk density than the bulk density of the residual region other than the hard side regions.

3. The mattress of claim 1, wherein each of the hard side regions has a bulk density in a range of between 0.025 g/cm³ and 0.100 g/cm³ and a residual region other than the hard side regions has a bulk density in a range of between 0.015 g/cm³ and 0.080 g/cm³, and the hard side regions are made to have the higher bulk density than the bulk density of the residual region other than the hard side regions.

4. The mattress of claim 1, wherein the three-dimensional netted structure has the hard side regions formed by compressing the left and right longitudinal side faces of the three-dimensional netted structure and/or by increasing a supply amount of the material to the left and right longitudinal side faces.

5. The mattress of claim 1, wherein the three-dimensional netted structure further has hard surface layers formed by compressing the left and right longitudinal side faces, a planar top face, and a bottom face, and the hard surface layers are made to have a higher relative bulk density than a bulk density of a residual region other than the hard side regions and the hard surface layers.

6. The mattress of claim 1, wherein the three-dimensional netted structure has a center section of a different bulk density formed in a site close to a center of the three-dimensional netted structure in a longitudinal direction and corresponding to a user's lower backside, and the center section is made to have a relatively higher bulk density than a bulk density of residual end sections other than the center section.

7. The mattress of claim 6, wherein the center section has a bulk density in a range of 0.035 to 0.110 g/cm³ and the residual end sections other than the center section have a bulk density in a range of 0.030 to 0.100 g/cm³.

8. A method of manufacturing of a dew condensation-preventing mattress, the method comprising:
a) melting a material containing at least a thermoplastic synthetic resin;
b) extruding the molten material downward from multiple openings arrayed in a substantially quadrilateral arrangement into filaments;
c) causing the filaments to free-fall in a vertical direction to a molding shoot having a molding inlet in a substantially quadrilateral shape having smaller dimensions than dimensions of the substantially quadrilateral arrangements of the multiple openings;
d) making the filaments looped and randomly entangled with partial thermal adhesion to form an aggregation of the filaments and simultaneously causing the aggregation of the filaments to come into contact with all four faces of the molding shoot and thereby to be compressed and molded;
e) hauling off the aggregation of the filaments by means of a pair of endless conveyers, which are arranged to face each other and are set to have a slower haul-off speed than a free-fall speed of the filaments;
f) making the hauled-off aggregation submerged into water to be cooled down and solidified to a three-dimensional netted structure; and
g) cutting the three-dimensional netted structure by a desired length, wherein four surface regions of the three-dimensional netted structure that are in contact with the four faces of the molding shoot are made to have a higher bulk density than a bulk density than a residual region other than the four surface regions.

9. The method of claim 8 further comprising: setting a higher supply amount of the material extruded from openings located close to opposed shorter sides of the substantially quadrilateral arrangement of the multiple openings than a supply amount of the material extruded from residual openings to form hard regions of a higher bulk density on left and right longitudinal faces of the three-dimensional netted structure.

10. The method of claim 8, wherein the haul-off speed of the endless conveyers is set to a range of 40 to 65 cm/minute, and a supply amount of the material extruded from the multiple openings to every area of 100 cm² in the substantially quadrilateral molding inlet of the molding shoot is set to a range of 0.200 to 0.400 kg/minute.

11. The mattress of claim 1, wherein the material further contains silver ion.

12. The mattress of claim 1, wherein the mattress is coated with a sprayed with or applied a stable chloride complex.

13. The mattress of claim 1, wherein the mattress is equipped with one of a plate heater, a sheet heater, or a hot air feeder to prevent a decrease in internal temperature of another mattress, a bed pad, or a floor surface.

14. A method of using of the mattress of claim 1, comprising placing the mattress under a bed pad or another mattress, above another mattress, or between two other mattresses or between a bed pad and another mattress or being used alone to assure good air permeability against the another mattress, against the bed pad, or against a floor surface.
